(19) United States
(12) Patent Application Publication
(10) Pub. No.: US 2014/0110474 A1
(43) Pub. Date: Apr. 24, 2014

(54) ANTENNA DEPLOYMENT

(71) Applicant: Shreyas Koliyot, Aberdeen (GB)

(72) Inventor: Shreyas Koliyot, Aberdeen (GB)

(73) Assignee: TECH 27 SYSTEMS LIMITED, Aberdeen (GB)

(21) Appl. No.: 14/123,378

(22) PCT Filed: May 21, 2012
(86) PCT No.: PCT/GB2012/051151

§ 371 Date: Dec. 17, 2013

(30) Foreign Application Priority Data
Jun. 2, 2011 (GB) 1109288.9

(51) Int. Cl. G06K 7/10; G06K 19/077

(52) U.S. Cl. CPC G06K 7/10009; G06K 19/07749
USPC 235/376; 235/492

(57) ABSTRACT

The invention concerns deployments of RFID antennas (105, 305), used for the tracking of running equipment used in hydrocarbon exploration and production. A diverter housing (101) is provided with an RFID antenna (105, 305) disposed proximal an upper end. Accordingly, the antenna will only detect an asset (323) as it is actually run, whilst being protected by virtue of residing underneath the drill floor but above the substructure. Once a riser has been run and the riser spider (401) is removed, the antenna remain in place allowing subsequent assets such as drill pipes or tubulars to be tracked. A tension ring is also provided with an RFID antenna disposed thereon, providing similar benefits. An associated asset tracking system and a tracking method are also provided which benefit from the above-mentioned advantages over known asset tracking systems and methods.

The present invention relates to the field of asset tracking, and in particular marine asset tracking. More specifically, the present invention concerns deployments of antennas, typically RFID antennas, used for the tracking of running equipment used in hydrocarbon exploration and production. Embodiments of the invention provide for improved tracking by virtue of the particular antenna locations selected. An asset tracking system and a corresponding method of tracking assets are also described.

### BACKGROUND TO THE INVENTION

Historically, asset tracking was facilitated by labelling or marking the assets with identification numbers or codes, for example by peening. However, even peened numbers become illegible over time and as such there is a risk that assets can be identified incorrectly and that as a result the logs are correspondingly incorrect.

In the past few years, radio frequency identification (RFID) technology has developed significantly and rugged RFID tags are now available that can be exposed to extreme temperatures and tough environments, making them ideally suited for use in drilling operations.

In the field of marine asset tracking, such RFID tags enable assets to be uniquely identified. It is known to interrogate or “scan” RFID tags on risers in order to create a detailed log of assets that have been run. This can be performed, for example, by a hand-held scanner operated by an engineer who scans each riser joint before it is run, or by an RFID antenna mounted on the drilling rig that interrogates the RFID tag when the riser joint is lifted onto the riser spider.

However, the applicant has identified a number of problems associated with current implementations of RFID marine asset tracking systems and, accordingly, it is an object of aspects of the invention to obviate and/or mitigate such deficiencies in the prior art.

### SUMMARY OF THE INVENTION

According to a first aspect of the invention, there is provided an asset tracking apparatus comprising a diverter housing and at least one RFID antenna disposed thereon, wherein the at least one RFID antenna is disposed proximal an upper end of the diverter housing.

Locating the at least one RFID antenna on the diverter housing, at an upper end thereof, provides a number of advantages. Firstly, the RFID antennas will only detect assets (for example running equipment such as drill pipes, risers, flex joints, telescopic joints, diverters, tubulars etc.) as they are actually run, as described in further detail in the specific description to follow, yet are protected because when installed they reside underneath the drill floor but above the substructure. Furthermore, even once a riser has been run and the riser spider is removed, the antenna remain in place allowing subsequent assets (e.g. drill string sections) to be tracked.

Preferably, the asset tracking apparatus comprises at least one aperture provided in a wall of the diverter housing, and a corresponding RFID antenna located proximal to the aperture for interrogation of RFID tags therethrough.

Preferably, the asset tracking apparatus comprises a plurality of apertures and a corresponding plurality of RFID antennas disposed circumferentially around the diverter housing.

Optionally, the diverter housing further comprises at least one RFID antenna support to attach the at least one RFID antenna to the diverter housing.

Advantageously, the RFID antenna support comprises at least one hinged portion to allow movement of the RFID antenna relative to the diverter housing. Preferably the RFID antenna support permits rotation and translation of the RFID antenna away from the diverter housing for inspection, servicing, repair and/or replacement. Preferably, or alternatively, the RFID antenna support provides a means for varying the distance between the RFID antenna and the diverter housing.

According to a second aspect of the invention there is provided a diverter housing sleeve comprising one or more RFID antennas and adapted for assembly with corresponding diverter housing components to provide a diverter housing in accordance with the first aspect.

Embodiments of the second aspect of the invention may include one or more features of the first aspect of the invention or its embodiments, or vice versa.

According to a third aspect of the invention, there is provided a diverter comprising a diverter housing according to the first aspect and/or a diverter housing sleeve according to the second aspect.

Embodiments of the third aspect of the invention may include one or more features of the first or second aspects of the invention or their embodiments, or vice versa.

According to a fourth aspect of the invention, there is provided an asset tracking system comprising one or more asset tracking apparatus according to the first and/or second aspects and a controller configured to receive RFID data from the one or more asset tracking apparatus.

Preferably, the asset tracking system further comprises a database comprising asset data, at least one link between the database and the controller, the system configured to exchange asset data between the controller and the database.

Preferably, asset data is exchange dependent on detection of an RFID tag associated with a corresponding asset.

Optionally, the controller is configured to determine a riser configuration dependent on data received from the database.

Preferably, the controller is configured to provide an alert in the event that an RFID tag associated with a riser joint is detected contrary to an expected riser joint according to the determined riser joint configuration.

Optionally, the asset tracking system further comprises one or more additional RFID antennas disposed at one or more further locations in a corresponding structure.

The further locations are preferably selected from the group comprising; underneath a drilling floor and above a substructure, in a substructure below the diverter housing, proximal the opening of a moonpool, within a moonpool, on a support ring or on a tension ring.

Preferably, the asset tracking system further comprises one or more running equipment, each of the one or more running equipment comprising one or more RFID tags for interrogation by the at least one RFID antenna of the asset tracking system.

The one or more running equipment may be selected from the group comprising drill pipes, risers, flex joints, telescopic joints, diverters, tubulars and the like.

Embodiments of the fourth aspect of the invention may include one or more features of the first, second or third aspects of the invention or their embodiments, or vice versa.

According to a fifth aspect of the invention, there is provided an asset tracking apparatus comprising a tension ring and at least one RFID antenna disposed on the tension ring.

Preferably, the apparatus further comprises one or more tensioners attached to the tension ring.

Most preferably, the at least one RFID antenna is disposed on the tension ring, radially inwards of one of said tensioners.

Preferably, the apparatus comprises a plurality of RFID antennas disposed radially inwards of a corresponding plurality of tensioners.

Embodiments of the fifth aspect of the invention may include one or more features of the first to fourth aspects of the invention or their embodiments, or vice versa.

According to a sixth aspect of the invention, there is provided an asset tracking system comprising one or more asset tracking apparatus according to the first and/or fourth aspects of the invention and a controller configured to receive RFID data from the one or more asset tracking apparatus.

Embodiments of the sixth aspect of the invention may include one or more features of the first to fifth aspects, particularly the fourth aspect, of the invention or their embodiments, or vice versa.

According to a seventh aspect of the invention, there is provided a drillship or drilling rig comprising an asset tracking system according to the fourth aspect or the sixth aspect.

Embodiments of the seventh aspect of the invention may include one or more features of any of the first to sixth aspects of the invention or their embodiments, or vice versa.

According to an eighth aspect of the invention there is provided a method of asset tracking comprising deploying an asset tracking apparatus according to the first and/or fourth aspects of the invention, and receiving RFID data from the one or more asset tracking apparatus as assets are run therethrough.

Optionally, the method further comprises running at least one asset, and interrogating at least one RFID tag associated with the asset to obtain RFID data associated with the asset.

Optionally, the method further comprises exchanging asset data with a database of asset data, dependent on detection of an RFID tag associated with a corresponding asset.

Embodiments of the eighth aspect of the invention may include one or more features corresponding to features of any of the first to seventh aspects of the invention or their embodiments, or vice versa.

According to a ninth aspect of the invention, there is provided a method of running a riser string, comprising tracking riser assets according to the asset tracking method of the eighth aspect.

According to a tenth aspect of the invention, there is provided a method of drilling a borehole, comprising tracking drill string assets according to the asset tracking method of the eighth aspect.

Embodiments of the ninth and tenth aspects of the invention may include one or more features corresponding to features of any of the first to eighth aspects of the invention or their embodiments, or vice versa.

### BRIEF DESCRIPTION OF THE DRAWINGS

There will now be described, by way of example only, various embodiments of the invention with reference to the drawings, of which:

FIG. 1 illustrates a diverter housing in accordance with an embodiment of at least one aspect of the invention in which a number of RFID antennas are deployed on a sleeve of the diverter housing;

FIG. 2 illustrates an alternative diverter housing in accordance with an embodiment of at least one aspect of the invention in which a number of RFID antennas are deployed on an alternative diverter housing;

FIG. 3 illustrates in schematic form a number of different RFID deployment positions as may be employed in an asset management system in accordance with an embodiment of at least one aspect of the invention;

FIG. 4 illustrates a drilling spider in which a number of RFID antennas are deployed over the drilling spider as may be employed in an asset management system in accordance with an embodiment of at least one aspect of the invention;

FIG. 5 illustrates (a) an alternative drilling spider in which a number of RFID antennas are deployed under the drilling spider and (b) a number of alternative RFID deployment positions as may be employed in an asset management system in accordance with an embodiment of at least one aspect of the invention;

FIG. 6 illustrates a tension ring in accordance with an embodiment of at least one aspect of the invention in which a number of RFID antennas are deployed on the support ring.

### DETAILED DESCRIPTION OF PREFERRED EMBODIMENTS

The invention is particularly concerned with tracking assets (for example running equipment such as drill pipes, risers, flex joints, telescopic joints, diverters, tubulars etc.) in marine drilling riser systems, although it will be understood to be applicable to any similar system, at sea or on land, in which it is desirable to track assets as they are run. Where examples are described in relation to, say, drillships, the skilled person will appreciate that these examples could be readily translated to be effective on jackup rigs, floating rigs or indeed land based drilling rigs. Likewise, references to a rotary table should not be considered as limiting the invention, as it will become evident that the invention applies to direct push rigs, top drive rigs, sonic and hammer type systems.

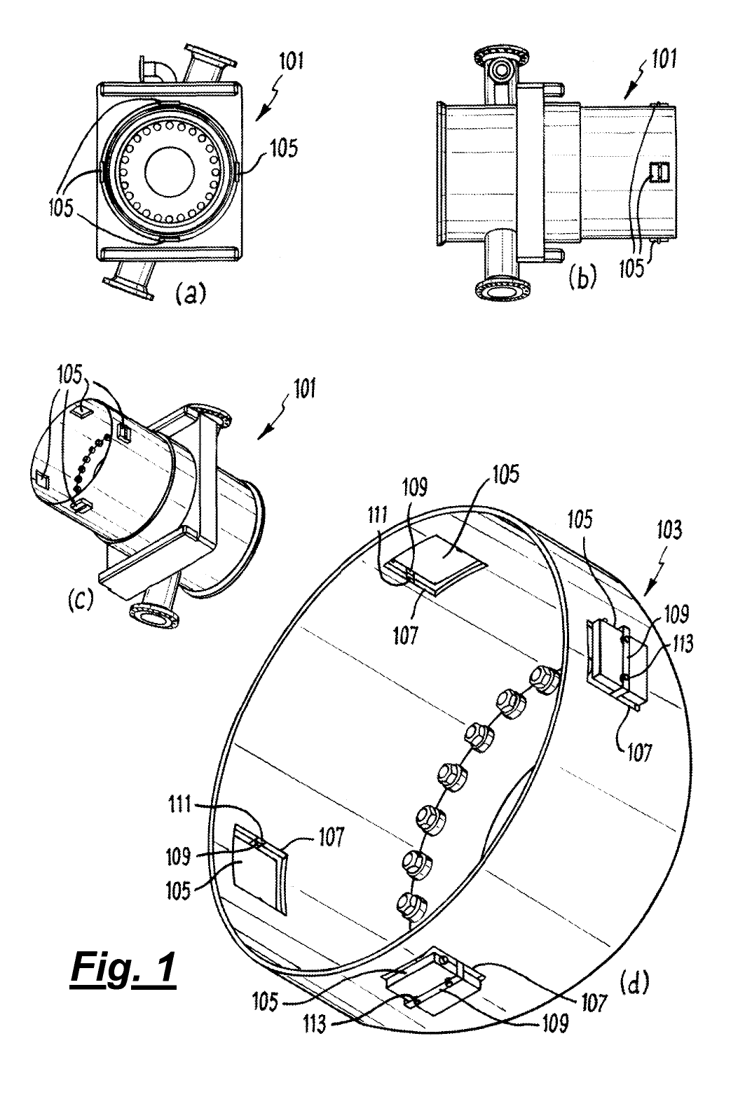

There now follows a description of a diverter housing 101 having RFID antennas disposed thereon in accordance with at least one aspect of the present invention. FIG. 1 illustrates an exemplary embodiment of said invention. The diverter housing 101 is shown in (a) a top-down view, (b) a side view, (c) a perspective view, and (d) a partial view showing detail of a sleeve 103 of the diverter housing 101 in which several RFID antennas 105 are mounted.

A number of apertures 107 are located in the wall of the diverter housing sleeve 103. The apertures may be formed or cut. The apertures 107 provide windows for corresponding RFID antennas 105 (or “interrogators” as they are referred to in RFID terminology) which are retained proximal to the apertures 107 by way of supports 109 that are generally u-shaped and affixed to the interior edges of the apertures 107 by fixing means 111 such as bolts or studs. Similarly, the RFID antennas 105 are affixed to the supports 109 by fixing means 113 such as bolts or studs. In these locations the RFID antennas 105 are readily able to interrogate RFID tags on any assets being run through the diverter.

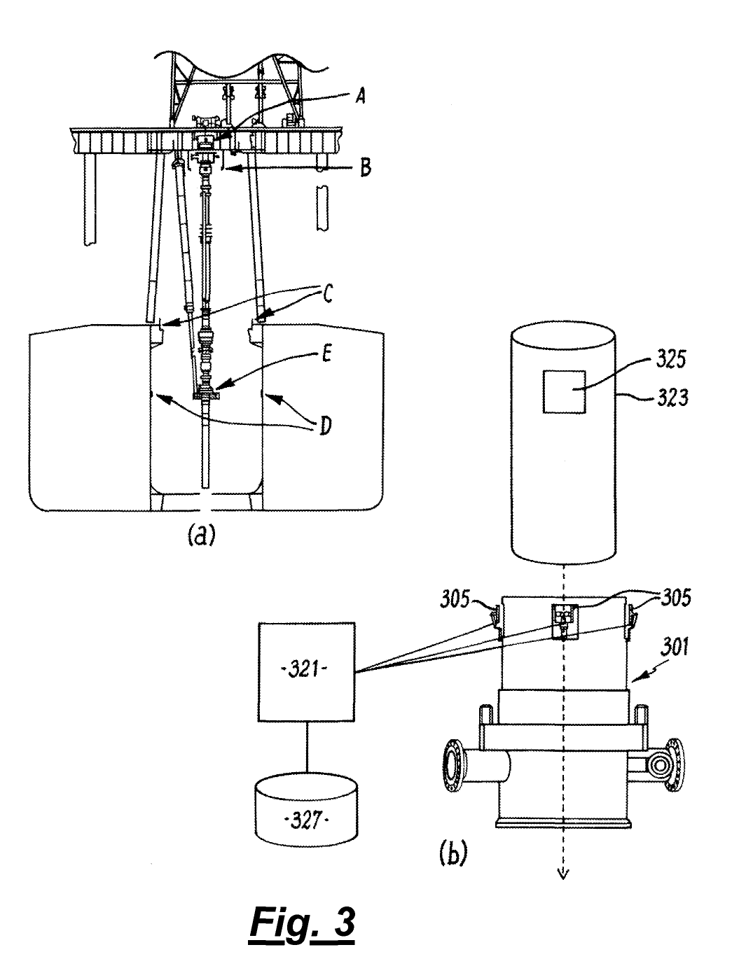

FIG. 1(b) shows how the diverter will be disposed in use, i.e. with the diverter sleeve 103 topmost, as illustrated in FIG. 3 for example. Accordingly, not only is it evident that the RFID antennas 105 are located above the flow line 115 but importantly (see FIG. 3) that in use the RFID antennas are located beneath the rotary table.

This deployment affords a number of advantages in asset tracking that to date have not been realised by conventional arrangements. Importantly, the position of the RFID antennas on the diverter (i.e. beneath the rotary table and above the flow line) results in vastly improved tracking reliability. Taking the example of a riser joint tagged with an RFID identifier, in prior art systems where the RFID identifier is read manually or using RFID antennas deployed on the drilling rig, there is a risk that the identifier will be read then not run (in which case the log must be modified), or that the identifier will be read by mistake (for example by passing too closely to the RFID antenna) which might go unnoticed.

Employing the invention, when the riser joint is run through the spider and through the diverter, the RFID antennas (preferentially located at a number of locations around the circumference of the sleeve) interrogate the RFID tag as it passes. Due to the position of the RFID antennas, this can only take place as the riser joint is being run. Because the RFID tags are only read when the riser joint is being run, the resulting log of riser joints is more accurate than possible with prior art systems because false detections are avoided.

In addition, after the riser has been deployed, and the riser spider and associated equipment removed, the antennas remain in place and sections of drill string or the like that are subsequently run can be identified and logged with the same advantages as enjoyed during running of the riser. Prior art systems are incapable of automatically tracking the drill string because the antennas would be removed prior to drilling.

Furthermore, although the antennas are located beneath the rotary table, they are still protected from damage by virtue of being housed within the diverter.

Therefore, in summary, the invention allows for improved tracking accuracy by placing the RFID antennas in a location where a positive determination that an asset has been run can be made, without exposing the RFID antennas themselves to a greater risk of fouling or being otherwise damaged. Furthermore, sections of the drill string (and other running equipment) can also be tracked.

It will be understood that tracking may also be performed as and when the assets are being retrieved.

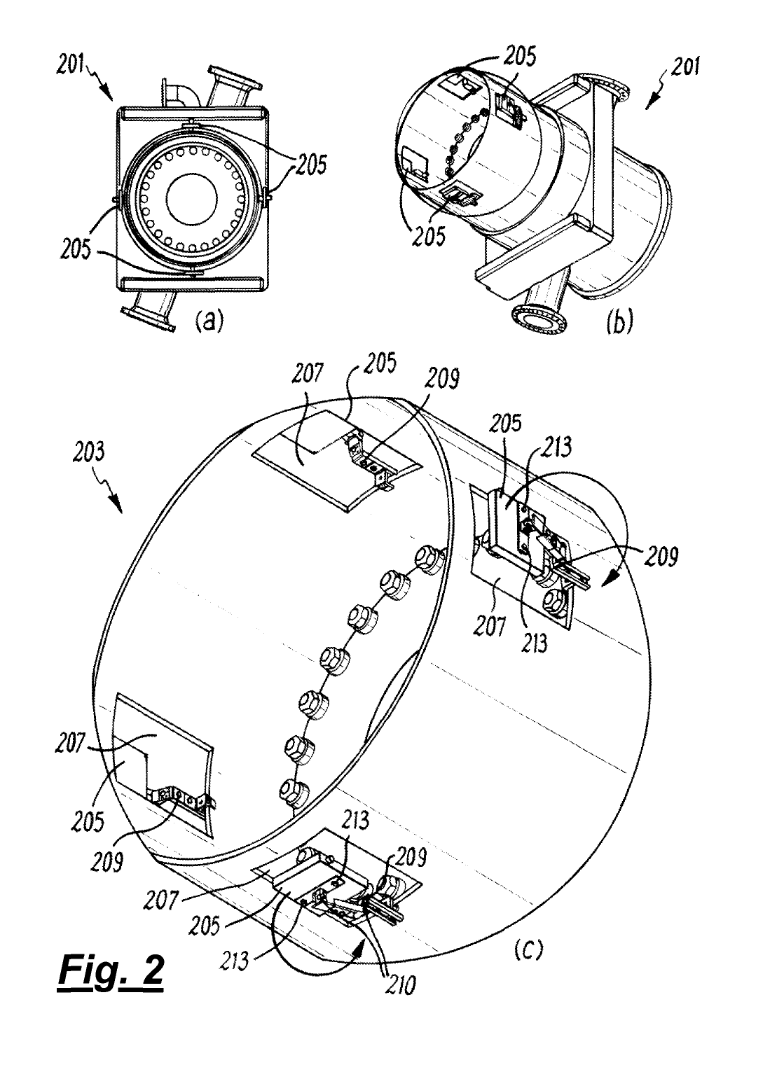

FIG. 2 illustrates another exemplary embodiment of the invention, sharing many features in common with the diverter housing 101 shown in FIG. 1. The alternative diverter housing 201 is shown in (a) a top-down view, (b) a perspective view and (c) a partial view showing detail of a sleeve 203 of the diverter housing 201 in which several RFID antennas 205 are mounted.

Similarly, a number of apertures 207 are located in the wall of the diverter housing sleeve 203 providing windows for corresponding RFID antennas 205 which are retained proximal to the apertures 207 by way of supports 209. The RFID antennas 205 are affixed to the supports 209 by fixing means 213. As before, the RFID antennas 205 are thereby positioned to interrogate RFID tags on any assets being run through the diverter.

In this embodiment, the supports 209 to which the antennas 205 are affixed differ from those illustrated in FIG. 1. The supports 209 in this case can be seen to comprise hinged portions 210 that enable the antenna to be manoeuvred into and out of location at the aperture 207 (as indicated by arrows) to assist with maintenance and also to allow variation of the distance between the RFID antennas 205 and the assets being run.

FIG. 3 illustrates a number of different RFID antenna deployments (specific to deployment on a drillship). RFID antennas are shown deployed (A) in the sleeves of the diverter housing 301 as per the invention, (B) in the sub-structure below the diverter housing 301, (C,D) in the moonpool, and (E) on the support ring. In practice, a combination of deployment positions (B), (C), (D) and (E) and any other deployments disclosed herein may be used to complement and/or supplement the deployment of the invention (as exemplified in FIG. 1 and FIG. 2) in order to effect an asset tracking system.

Such an asset tracking system, in accordance with an aspect of the invention, comprises a diverter housing 301 within which RFID antennas 305 are deployed in the manner described in relation to FIGS. 1 and 2, and a controller 321 which receives identification data from the antennas 305 via a wireless link (represented figuratively by dashed lines). The data is read from an RFID tag 325 affixed to a riser joint 323 as it is run (represented figuratively by an arrow) through the diverter housing 301, from which the controller is able to identify the specific riser joint 323. This may be achieved by interrogating a database 327 of RFID data.

Note that the database 327 may be employed to store data relating to specific riser joints, for example usage history, which can be updated in real-time as riser joints are run and/or retrieved. Operational statistics and parameters can also be updated and/or retrieved as necessary for further use by the controller (for example in formulating riser deployment strategies). The database 327 may be accessible via a network allowing other controllers (and hence other operations) to share data.

As discussed above, and as evident from the illustration in FIG. 3(b), the position of the RFID antennas 305 is such that the asset 323 is only identified once it has been run. The additional antenna deployment positions shown may provide complementary information to that gleaned from the diverter housing-mounted antennas 305 as will be appreciated by the skilled person; for example by providing an early warning that the wrong riser section is about to be run, or that a riser section has failed to be detected by an antenna located further down the system (perhaps indicative of a jam or that the RFID tag has been damaged between successive antenna deployment positions).

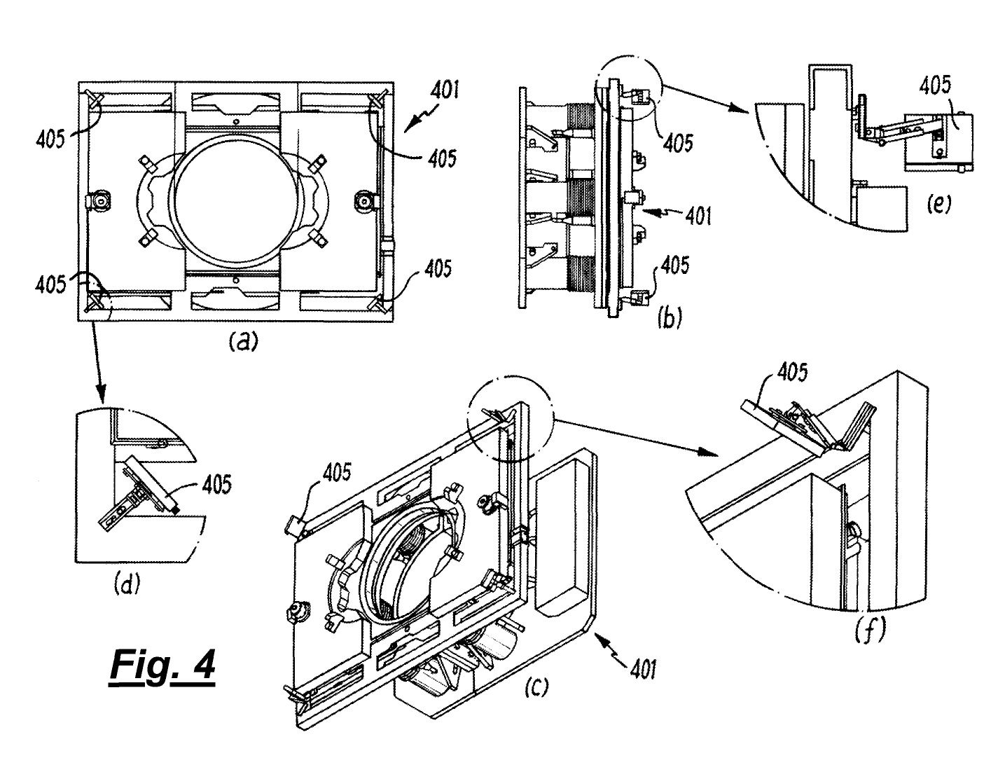

FIG. 4 illustrates a riser spider 401 assembly in which a number of RFID antennas 405 are deployed over the spider 401. The spider 401 is shown in (a) a top-down view, (b) a side view, and (c) a perspective view, as well as (d), (e) and (f) showing further detail of the mounted antennas 405.

As noted above, the riser spider 401 may be used to supplement the deployment of the invention (as exemplified in FIG. 1 and FIG. 2) in order to effect an asset tracking system.

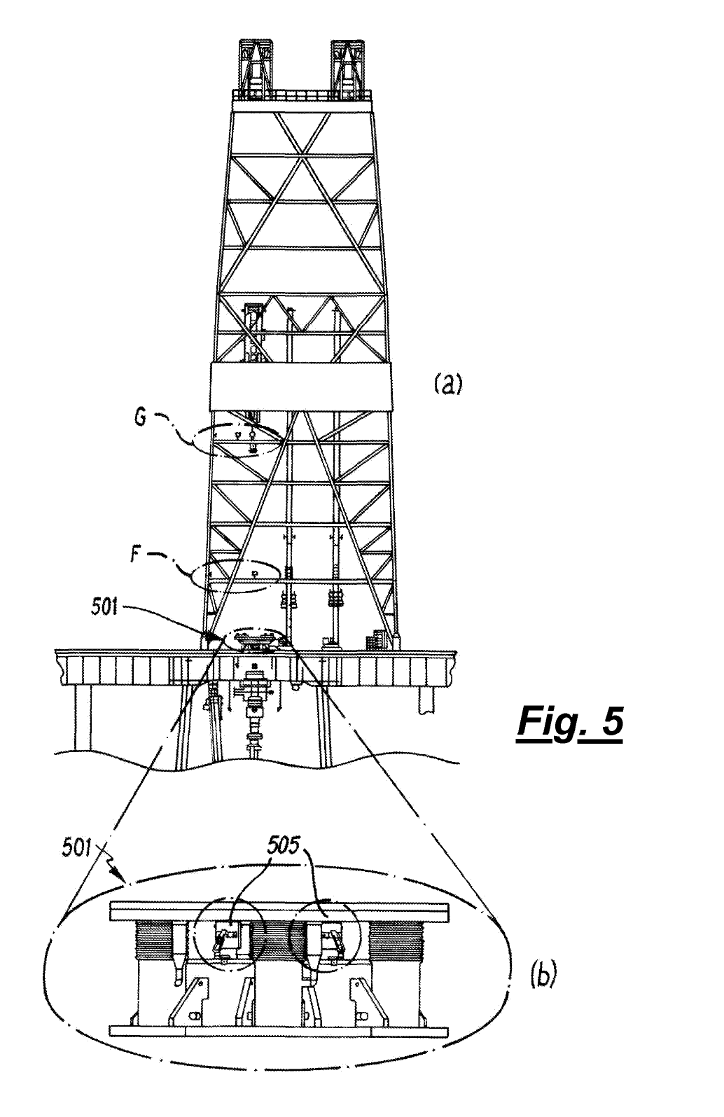

Similarly, FIG. 5 illustrates a further alternative embodiment of the invention in which a number of RFID antennas 505 are deployed under the drilling spider 501. Specifically, the antennas are deployed on the gimbal, as shown in FIG. 5(b). FIG. 5(a) illustrates a number of additional alternative deployment positions, namely (F) at the bottom of the derrick and (G) at the top of the derrick. These alternative deployment positions may be utilised in combination with the deployment positions shown in FIG. 3 and any other deployments disclosed herein to complement and/or supplement the deployment of the invention as exemplified in FIG. 1 and FIG. 2 in order to effect an asset tracking system.

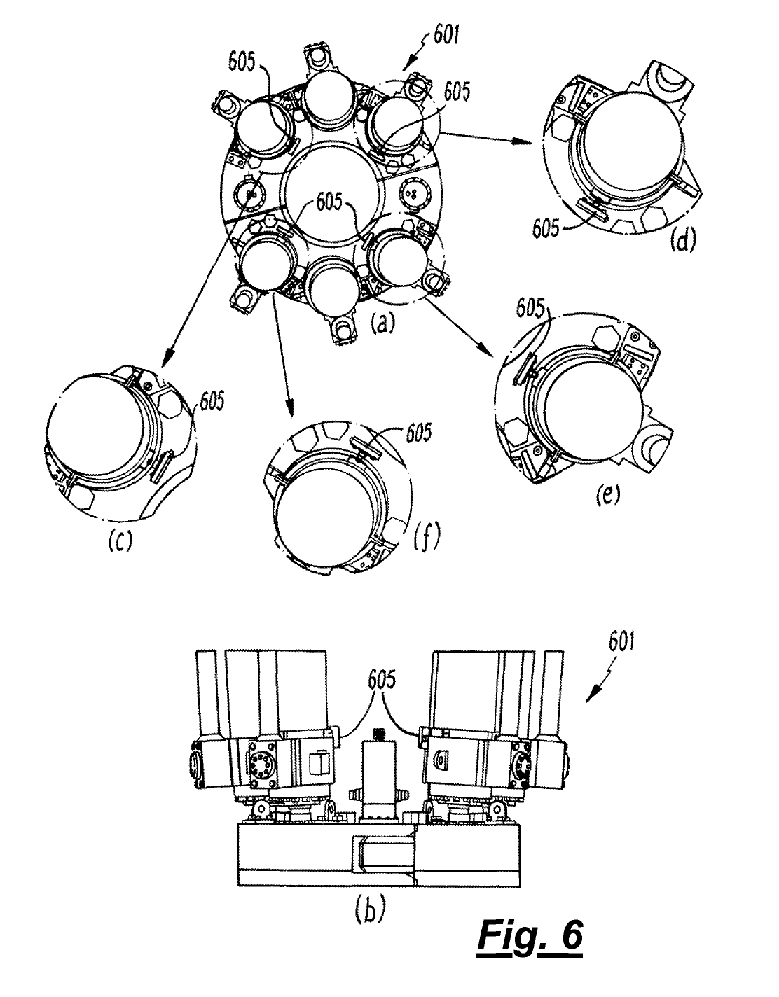

FIG. 6 illustrates a yet further alternative embodiment of the invention in which a number of RFID antennas 605 are deployed on the support ring 601 (for example as illustrated in FIG. 3 at deployment position (E)). The support ring 601 is shown in (a) a top-down view, and (b) a side view, with (c), (d), (e), and (f) showing further detail of the location of the mounted antennas 605. As is evident from FIG. 6 (a) in particular, the RFID antennas are deployed so as to be proximal to the central aperture through which, in use, a telescopic joint may run. Alternatively, the support ring may be hinged at one side with a releasable closure on the opposite side to enable the support ring to be opened, manoeuvred into position around the telescopic joint and closed, as will be understood by the skilled person.

As will be readily apparent, the antenna deployment illustrated in FIG. 6 shares a number of advantages with the deployments illustrated in FIG. 1 and FIG. 2.

For example, the RFID antennas interrogate the RFID tag on an asset (be it a riser joint or a drill string section or the like) as it passes. Due to the position of the RFID antennas, this can only take place if the asset has been run. As the RFID tags are only read when the asset has been run, a resulting asset log is more accurate than possible with prior art systems because false detections are avoided.

In addition, after the riser has been deployed, and the riser spider and associated equipment removed, the antennas 605 remain in place as long as the support ring is in place and sections of drill string that are subsequently run can be identified and logged with the same advantages as enjoyed during running of the riser. As described above, prior art systems are incapable of automatically tracking the drill string because the antennas are removed prior to drilling.

Furthermore, the RFID antennas 605 are protected from damage by virtue of being located inwards of the support ring, proximal to (but spaced from) the telescopic joint or the like around which the support ring is closed.

Therefore, in summary, this deployment also allows for improved tracking accuracy by placing the RFID antennas in a location where a positive determination that an asset or assets (for example running equipment such as drill pipes, risers, flex joints, telescopic joints, diverters, tubulars etc.) has been run—or has been retrieved—can be made, while also protecting the antennas from being damaged.

The invention concerns deployments of antennas, typically RFID antennas, used for the tracking of running equipment used in hydrocarbon exploration and production. A diverter housing is provided with an RFID antenna disposed proximal an upper end. Accordingly, the RFID antenna will only detect an asset as it is actually run, whilst being protected by virtue of residing underneath the drill floor but above the substructure. Once a riser has been run and the riser spider is removed, the antenna remain in place allowing subsequent assets such as drill pipes or tubulars to be tracked. A tension ring is also provided with an RFID antenna disposed thereon, providing similar benefits. An associated asset tracking system and a tracking method are also provided which benefit from the above-mentioned advantages over known asset tracking systems and methods.

Various modifications may be made within the scope of the invention as herein intended, and embodiments of the invention may include combinations of features other than those expressly claimed.

1. An asset tracking apparatus comprising a diverter housing and at least one RFID antenna disposed thereon, wherein the at least one RFID antenna is disposed proximal an upper end of the diverter housing.

2. An asset tracking apparatus according to claim 1, wherein the asset tracking apparatus comprises at least one aperture provided in a wall of the diverter housing, and a corresponding RFID antenna located proximal to the aperture for interrogation of RFID tags therethrough.

3. An asset tracking apparatus according to claim 1, wherein the asset tracking apparatus comprises a plurality of apertures and a corresponding plurality of RFID antennas disposed circumferentially around the diverter housing.

4. An asset tracking apparatus according to any of claims 1 to 3, wherein the diverter housing further comprises at least one RFID antenna support to attach the at least one RFID antenna to the diverter housing.

5. An asset tracking apparatus according to claim 4, wherein the RFID antenna support comprises at least one hinged portion to allow movement of the RFID antenna relative to the diverter housing.

6. An asset tracking apparatus according to claim 5, wherein the RFID antenna support permits rotation and translation of the RFID antenna away from the diverter housing for inspection, servicing, repair and/or replacement.

7. An asset tracking apparatus according to claim 5 or claim 6, wherein the RFID antenna support provides a means for varying the distance between the RFID antenna and the diverter housing.

8. A diverter housing sleeve comprising one or more RFID antennas and adapted for assembly with corresponding diverter housing components to provide a diverter housing in accordance with any of claims 1 to 7.

9. A diverter comprising a diverter housing according to any of claims 1 to 7.

10. A diverter comprising a diverter housing sleeve according to claim 8.

11. An asset tracking system comprising one or more asset tracking apparatus according to any of claims 1 to 10 and a controller configured to receive RFID data from the one or more asset tracking apparatus.

12. An asset tracking system according to claim 11, wherein the asset tracking system further comprises a database comprising asset data, at least one link between the database and the controller, the system configured to exchange asset data between the controller and the database.

13. An asset tracking system according to claim 12, wherein asset data is exchanged dependent on detection of an RFID tag associated with a corresponding asset.

14. An asset tracking system according to any of claims 11 to 13, wherein the controller is configured to determine a riser configuration dependent on data received from the database.

15. An asset tracking system according to claim 14, wherein the controller is configured to provide an alert in the event that an RFID tag associated with a riser joint is detected contrary to an expected riser joint according to the determined riser joint configuration.

16. An asset tracking system according to any of claims 11 to 15, wherein the asset tracking system further comprises one or more additional RFID antennas disposed at one or more further locations in a corresponding structure.

17. An asset tracking system according to claim 16, wherein the one or more further locations are selected from the group comprising; underneath a drilling floor and above a substructure, in a substructure below the diverter housing, proximal the opening of a moonpool, within a moonpool, on a support ring or on a tension ring.

18. An asset tracking system according to any of claims 11 to 17, wherein the asset tracking system further comprises one or more running equipment, each of the one or more running equipment comprising one or more RFID tags for interrogation by the at least one RFID antenna of the asset tracking system.

19. An asset tracking system according to claim 18, wherein the one or more running equipment are selected from the group comprising drill pipes, risers, flex joints, telescopic joints, diverters, and tubulars.

20. An asset tracking apparatus comprising a tension ring and at least one RFID antenna disposed on the tension ring.

21. An asset tracking apparatus according to claim 20, further comprising one or more tensioners attached to the tension ring.

22. An asset tracking apparatus according to claim 20 or claim 21, wherein the at least one RFID antenna is disposed on the tension ring, radially inwards of one of said tensioners.

23. An asset tracking apparatus according to claim 20 or claim 21, wherein the apparatus comprises a plurality of RFID antennas disposed radially inwards of a corresponding plurality of tensioners.

24. An asset tracking system comprising one or more asset tracking apparatus according to any of claims 20 to 23 and a controller configured to receive RFID data from the one or more asset tracking apparatus.

25. An asset tracking system according to claim 24, further comprising one or more asset tracking apparatus according to any of claims 1 to 10.

26. A drillship or drilling rig comprising an asset tracking system according to any of claims 11 to 19 or an asset tracking system according to claim 24 or claim 25.

27. A method of asset tracking comprising deploying an asset tracking apparatus according to any of claims 1 to 10 and/or an asset tracking apparatus according to any of claims 20 to 23, and receiving RFID data from the one or more asset tracking apparatus as assets are run therethrough.

28. A method of asset tracking according to claim 27, wherein the method further comprises running at least one asset, and interrogating at least one RFID tag associated with the asset to obtain RFID data associated with the asset.

29. A method of asset tracking according to claim 27 or claim 28, wherein the method further comprises exchanging asset data with a database of asset data, dependent on detection of an RFID tag associated with a corresponding asset.

30. A method of running a riser string, comprising tracking riser assets according to the asset tracking method of claim 28 or claim 29.

31. A method of drilling a borehole, comprising tracking drill string assets according to the asset tracking method of claim 28 or claim 29.
